(19) United States
(12) Patent Application Publication
(10) Pub. No.: US 2022/0072464 A1
(43) Pub. Date: Mar. 10, 2022

(54) FILTER WITH COMMUNICATOR

(71) Applicant: ZEITGEIST VENTURES DEUTSCHLAND GMBH, Haan (DE)

(72) Inventors: Raymond SIMPSON jr, Nassau (BS); Gert TRAUERNICHT, Wuppertal (DE); Tim KRIEGLSTEIN, Ratingen (DE)

(21) Appl. No.: 17/421,310

(22) PCT Filed: Feb. 6, 2020
(86) PCT No.: PCT/IB2020/050946

§ 371 Date: Jul. 7, 2021

(30) Foreign Application Priority Data
Feb. 6, 2019 (DE) 10 2019 102 969.4

(51) Int. Cl. B01D 46/00; B65D 85/07; B65D 81/20; B01D 46/10; B01D 46/46; B01D 46/42

(52) U.S. Cl. CPC B01D 46/0086; B65D 85/07; B65D 81/2023; B01D 46/10; B01D 2279/50; B01D 46/46; B01D 46/0005; B01D 46/0098; B01D 46/429; B01D 46/009

(57) ABSTRACT

The invention relates inter alia to a device (10) for filtering air flows, comprising a filter frame (22), an exchangeable filter nonwoven (23) and a holding device (24) by means of which the filter nonwoven can be held in place on the filter frame. A special feature of the invention is inter alia that the filter nonwoven is compressed and is arranged in a transport packaging (30) particularly in a vacuumized state.

According to a first aspect, the invention relates to an apparatus according to the preamble of claim 1.

Apparatuses for filtering air flows are widespread and are used in many different fields of technology. The present invention in particular relates to air filters and Apparatuses for filtering air flows in buildings, in particular for air-conditioning systems, also including heating, cooling and ventilation systems.

In larger buildings, for example hotels, administrative buildings, etc., a large number of air filters are often provided, which have to be regularly replaced.

The filters comprise filter fleeces, which filter particles or airborne particles out of the circulated air. Depending on the level of loading of the air with the substances to be filtered, the filter fleeces become clogged after a certain service life and the filter fleeces need to be replaced.

Proceeding therefrom, the object of the invention is to improve an apparatus known per se according to the preamble of claim 1.

The invention achieves this object by the features of claim 1, in particular by those of the characterizing part, and is accordingly characterized in that the filter fleece is in transport packaging so as to be compressed and in particular evacuated.

The principle of the invention is essentially to configure the replaceable filter fleece so as to be compressed and in particular evacuated. The filter fleece can be surrounded by transport packaging. The transport packaging may for example be provided by a plastics film, in particular by an airtight, transparent plastics film.

According to the invention, the apparatus according to the invention is used for filtering air flows, in particular in building technology. In particular, the apparatus that is also referred to in the present patent application as an air filter may be part of an air-conditioning system or, in more general terms, may be part of a building ventilation system. A building ventilation system of this kind may comprise a large number of air filters.

An individual air filter comprises a filter frame, to which a replaceable, i.e. exchangeable, filter fleece can be fixed. This takes place with the aid of a retaining device. The retaining device is used to detachably fix the filter fleece to the filter frame.

In principle, the frame and the retaining device can be designed in any manner.

The invention also covers Apparatuses which comprise a filter frame to which a filter fleece can be fixed without the aid of a retaining device, and for example can be inserted into a holder provided there.

The invention further covers Apparatuses in which a retaining device is provided for fixing the filter fleece to the filter frame, and which can be fixed, for example clipped or clamped, to the filter frame directly, without the aid of additional auxiliary means.

The invention further covers Apparatuses in which the retaining device can be moved pivotally relative to the filter frame, and for example can be transferred between an open working position for replacing the filter fleece and a closed rest position with the filter fleece mounted.

The invention furthermore covers Apparatuses in which the retaining device is arranged so as to be completely detachable from the installation frame.

The filter fleece according to the invention is advantageously a planar element, the extension of which is considerably greater in a plane than the extension in a direction transverse to the plane. In other words, the filter fleece according to the invention is an element which has a height and a width which is considerably greater than the wall thickness or thickness of the filter fleece. The filter fleece may have a rectangular or square contour, but also may have a circular or oval contour or a contour formed by a polygonal shape or by straight and curved portions.

Within the meaning of the invention, the filter fleece may be provided by any material adapted to a relevant intended purpose of the filter. This material may in particular be a textile, homogeneous or inhomogeneous material consisting of one or more layers. In particular, materials are considered which consist of natural or artificial fibers which are matted together, and also foams, textile laid webs, knitted fabrics, woven fabrics or composite materials made of a plurality of different materials and/or layers and/or plies, which comprise at least one of the above-mentioned materials.

A filter fleece within the meaning of the present patent application comprises any materials that can filter particles out of the air flowing through the filter materials and are designed to be compressible.

The filter fleece according to the invention is in particular formed in the manner of a mat and has a height H, a width B and a thickness D.

According to the invention, the filter fleece is in transport packaging so as to be compressed and in particular evacuated. The filter fleece is in particular compressed by evacuation. However, the invention also covers embodiments in which the filter fleece is accommodated in transport packaging in a compressed manner without there being a vacuum.

Compared with a normal or rest state of the filter fleece, a compressed state of the filter fleece is characterized in that, in the compressed state of the filter fleece, its height H, width B and thickness D are considerably lower than in the non-compressed state.

According to the invention, the dimensions of the filter fleece can be considerably reduced as a result of the compression. According to the invention, a reduction in the volume of a filter fleece (which is defined by the measurements width×height×thickness) can in particular be reduced to a fraction.

As a result, according to the invention it is achieved that the transport volume and also the space required for storing the filter fleeces can be considerably reduced.

In large buildings, such as hotels or administrative buildings, a large number of filter fleeces, e.g. hundreds of filter fleeces, need to be replaced regularly, e.g. every six months, according to the maintenance plans.

Currently, filter fleeces are not transported or stored in a compressed state.

Using the invention, the transport volume and also the space required for storing the filter fleeces can be considerably reduced.

The filter fleece according to the invention can be used to filter dust, pollen, pollutants, fats, viruses, bacteria or other particles out of the air, depending on the intended purpose.

The filter fleece to be used according to the invention in particular has a mat-like, i.e. planar, structure. The invention also covers filter fleeces which are designed in the manner of fluted filters.

According to another aspect, the invention relates to a filter fleece according to the preamble of claim 2.

Proceeding therefrom, the object of the invention is to develop a filter fleece known per se.

The invention achieves this object by the features of claim 2, in particular by those of the characterizing part, and is accordingly characterized in that the filter fleece is in transport packaging so as to be compressed and in particular evacuated.

For describing the advantages of the principle of the invention, in order to prevent any repetition, reference is made to the above comments for claim 1, which are applicable, mutatis mutandis, to the invention according to claim 2.

According to another advantageous configuration of the invention, the invention relates to a plurality of filter fleeces according to claim 2. The special feature is that the plurality of filter fleeces are together surrounded by in particular evacuated transport packaging. As a result, a multi-pack of compressed filter fleeces can be provided, which keeps the number of items of transport packaging low.

According to another advantageous configuration of the invention according to claim 4, in a plurality of filter fleeces, each individual filter fleece is surrounded by an in particular evacuated transport packaging. In this case, it is provided that the individual items of transport packaging are fastened to one another in order to thus provide a transport and storage unit that can be easily handled.

According to another aspect, the invention relates to a method according to claim 5.

Proceeding from a method known per se for providing a filter fleece, the object of the invention is to develop the method such that it allows for simplified handling.

The invention achieves this object by the features of claim 5.

In order to prevent any repetition, with regard to describing the advantages and explaining the features of the invention according to claim 5, reference is made to the above comments, which are also applicable, mutatis mutandis, to the invention according to claim 5.

According to another aspect, the invention relates to an apparatus according to the preamble of claim 6.

Proceeding from an apparatus known per se having the features of the preamble of claim 6, the object of the invention is to provide an improved apparatus of this type.

This invention achieves this object by the features of claim 6.

According to the invention, a sensor is on the filter frame. In this respect, the apparatus according to the invention according to claim 6 comprises a filter frame, a replaceable filter fleece, which can be detachably fixed to the filter frame, and a sensor attached to the filter frame.

According to a variant, the sensor is directly on the filter fleece.

According to another variant of the invention, the sensor is on a retaining device for the filter fleece.

In one embodiment of the invention, the sensor may be designed to detect information regarding the filter fleece. In particular, a property of the filter fleece can be determined by the sensor. A property of the filter fleece may for example include a type of the filter fleece, e.g. a particular article number or a direct or indirect piece of information regarding the material characteristics or the age or the place of manufacture or the manufacturing method or the suitability of the filter fleece or the scope of application of the filter fleece. According to a variant of the invention, the sensor can directly detect the property of the filter fleece, for example by optical, acoustic or electromagnetic means or in another way by the sensor carrying out a measurement of the filter fleece. For example, the sensor may interact with an RFID tag on the filter fleece in the manner of an RFID reader. Other electromagnetic transmitting mechanisms, such as NFC, Bluetooth, WLAN, etc., also come into consideration. The invention also covers the case in which the sensor can detect and process an optical marker on the filter fleece, e.g. a barcode or an ID number. The sensor can thus identify information regarding the filter fleece. According to the invention, information can be determined or identified when the filter fleece is transported to, brought closer to or inserted into the sensor and/or the filter frame. To do this, a trigger element may also cooperate with the sensor, for example, which is actuated by a user in order to instigate measurement or detection by the sensor.

According to a variant of the invention, the sensor is alternatively and/or additionally designed such that a status of the filter fleece can be determined by the sensor. A status is considered to be information that indirectly or directly allows a statement to be made regarding the state of the filter. For example, this may be information regarding the service life reached or a level of soiling or a degree of clogging, or may be information stating that the filter fleece needs to be replaced, for example because a maintenance interval has been reached.

According to another embodiment of the invention, the sensor is designed to transmit information to a central controller of a system for filtering air flows. In the context of the present patent application, any suitable computing unit that can process information is considered to be a central controller of a system for filtering air flows. This information can preferably be transmitted contactlessly, in particular via electromagnetic waves, or optically, such that the controller or the control room of the system can access and process this information and/or take the information into account.

The principle of the invention according to claim 6 is that the above-described sensor is provided to be permanently on the filter frame. The filter frame may for example consist of plastics material or metal, and may be designed to have a long service life. By contrast, the filter material, i.e. the filter fleece, can be replaced or exchanged after a predetermined service life or a predetermined level of soiling has been reached. The sensor, which may be an expensive or high-quality component, may remain on the filter frame, even while the filter fleece is being replaced. The filter material may be considerably less expensive than the filter frame and/or the sensor. For the purpose of replacing the filter fleece, it is therefore only necessary to replace the filter fleece, and the filter frame and the sensor can be reused.

According to an advantageous configuration of the invention, the sensor is designed such that a property of the filter fleece can be determined thereby. In this variant of the invention, the sensor can identify or infer information regarding the filter in this respect. This also includes the option of communicating with the sensor, after a new filter fleece has been inserted, by actuating a reset button or another actuating element and in this way e.g. signaling to the sensor that a new filter fleece has been inserted. For example, a counter apparatus can then restart counting, and e.g. can run until a prescribed filter service life is reached.

The invention also covers the case in which the sensor identifies a property of the filter fleece, e.g. a particular article number or an identification number or a filter type. This may for example be carried out by an optical or electromagnetic measurement. The invention also covers the case in which the filter fleece comprises a corresponding marker, which can be read out by the sensor.

The invention also covers the case in which a property of the filter fleece is indirectly identified by the sensor. This may be carried out, for example, with the aid of a separate auxiliary apparatus, e.g. a smart phone or a mobile electronic device. In this case, it may be provided that an operator who is changing and reinserting a filter fleece communicates to the sensor the fact that a new filter fleece has been inserted, wirelessly or alternatively also in a wired manner, with the aid of a handset, e.g. a smart phone. In this way, a property of the filter fleece or the fact that a new filter fleece has been inserted can be communicated to the sensor.

According to another configuration of the invention, it may be provided that a status of the filter fleece can be determined by the sensor. For example, the level of soiling or a service life of the filter fleece in the filter frame can be directly or indirectly detected by the sensor.

According to another advantageous configuration of the invention, information can be transmitted to a controller of a system for filtering air flows by the the sensor. The sensor can for example transmit to the controller information regarding the status of the filter fleece connected to the filter frame and/or information regarding the type of connected filter fleece or information regarding the fact that a new filter fleece is connected, or information regarding an identification number of the filter fleece.

According to an advantageous configuration of the invention, the sensor is securely on the filter frame. The connection may for example be established with the aid of screws, welding, bonding, riveting or other suitable types of fastening.

According to another advantageous configuration of the invention, the sensor remains in an arrangement position on the filter frame while the filter fleece is being replaced.

According to another aspect, the invention relates to an apparatus according to the preamble of claim 13.

Proceeding from an apparatus having the features of the preamble of claim 13, the object of the invention is to develop the known apparatus such that simplified handling is made possible and such that there is in particular the option of incorporating the apparatus into automated maintenance processes in principle.

The invention achieves this object by the features of claim 13, in particular by those of the characterizing part, and is accordingly characterized in that a sensor is on the filter frame or on the filter fleece or on a retaining device for the filter fleece that can determine and/or detect sensor information regarding a property of the filter fleece, e.g. an article number or a filter type.

The principle of the invention essentially consists in assigning a sensor to the apparatus. The sensor is in particular fixed, in particular detachably fixed, to the filter frame. Using the sensor, information regarding a property of the filter fleece can be detected or determined.

According to a variant, the sensor is directly on the filter fleece. According to another variant of the invention, the sensor is on a retaining device for the filter fleece.

For example, within the meaning of the invention, such information is determined when the sensor detects information regarding a property of the filter fleece directly from the filter fleece. For example, a barcode, an identification number or the like can be read out using optical or electromechanical means, or information that is directly on the filter fleece or is in an information carrier on the filter fleece can be read out with the aid of electromagnetic waves, for example using RFID tags or NFC technology. The information may for example be determined by the sensor when a filter fleece, in particular a new filter fleece, is brought closer to, inserted into or fastened to the filter frame. For example, a determining step of this kind can be carried out automatically every time a filter fleece is merely brought close enough to the sensor or when a button or switch is actuated while the filter fleece is being fastened to the filter frame, for example by fastening a retaining device to the filter frame or by moving a latch element.

As an alternative to automatically determining information, information regarding the property of the filter fleece can also be detected by the sensor with the aid of a separate apparatus, e.g. a handset or a mobile telephone or a portable computer or the like. For example, therefore, while replacing a filter fleece and inserting a new filter fleece, an operator can manually, with the aid of an external handset of this kind, transmit information regarding a property of the filter fleece directly or indirectly from the separate handset to the sensor. The sensor can be designed to store information of this kind. In particular, the information can be kept available in a memory of the sensor for retrieval.

In a variant of the invention, the information can be transmitted, e.g. wirelessly transmitted, from the sensor element to an external element, e.g. to a controller or a control room of a system for filtering air flows.

Within the meaning of the present patent application, information regarding a property of the filter fleece may for example be information regarding the type of filter fleece, e.g. a variety, an article number, a use type or a field of use, indications of size, such as dimensions or density, information regarding expiry date, information regarding a manufacturing date, or information regarding the material of the filter fleece.

Status information can also be considered to be information regarding a property of the filter fleece. Status information regarding the filter fleece is for example information regarding the current level of soiling or soiling state, or the service life that has already been reached, or information regarding the remaining time until the filter fleece needs to be replaced, as prescribed by a maintenance interval.

According to an advantageous configuration of the invention, a memory element, in which the information regarding the property of the filter fleece can be stored, is assigned to the sensor. A memory element of this kind may be a direct component of the sensor or may be assigned to the sensor as a separate electronic component and connected thereto.

According to an advantageous configuration of the invention, a status of the filter fleece, in particular a level of soiling or a service life of the filter fleece, can be determined by the sensor.

According to this configuration of the invention, the status of the filter fleece can be determined by the sensor itself. Here, the level of soiling of the filter fleece can be monitored and/or evaluated by suitable measurements, for example by optical, acoustic, capacitive, inductive, electromagnetic or mechanical measurements, or alternatively by pressure measurements or moisture measurements, or also by continuously carrying out corresponding measurements.

The sensor may also comprise a measuring head or may be provided by a measuring head which is fastened to or abuts the filter fleece directly. A measuring head of this kind may for example also project inwards over an inner circumferential contour of a filter frame or may be within such an inner circumferential contour of a filter frame. The measuring head may be introduced directly into the material of the filter fleece, for example may be inserted therein, or may be directly attached to the filter fleece in another suitable manner. A measuring head of this kind may also be on a retaining device for the filter fleece and may abut or penetrate the filter fleece when mounted.

A measuring head of this kind may for example also comprise a body portion, which reaches from the air-inlet side of the filter fleece to the air-outlet side of the filter fleece. A measuring head of this kind may in particular be designed to measure, monitor or identify pressure differences between the inlet side and the outlet side, in order for it to be possible to make a statement on the soiling state of the filter fleece on the basis of the determined measured values.

The measuring head may be connected to other components of the sensor, which are in particular on the filter frame, for example wirelessly or in a wired manner, as a component of a sensor. The invention also covers the case in which the measuring head itself comprises the required measuring and/or transmitting and/or memory elements and its own power supply.

According to another advantageous configuration of the invention, information can be transmitted to a controller of a system for filtering air flows by the sensor. This information can be transmitted wirelessly, but also optionally in a wired manner, by the sensor directly or by a communication module connected to the sensor. The control room or controller of a system of this kind can carry out maintenance processes or initiate maintenance measures in an optimized manner with the knowledge of the status information for a plurality of air filters or filter fleeces. Therefore, for example by monitoring the level of soiling of individual filter fleeces, a decision can be made as to whether maintenance intervals are shortened or extended, or as to whether only individual filter fleeces from a large number of filter fleeces have to be replaced, for example. As a result, maintenance can be carried out efficiently and cost-effectively.

According to another advantageous configuration of the invention, the filter fleece is designed to be replaceable. This makes it possible to provide an apparatus of which the filter frame and sensor are reusable. This can provide advantages in terms of cost.

If the new filter fleece can be identified by the sensor when replacing a filter fleece, and if it is only that case that the sensor is designed such that it can even identify that a new filter fleece is inserted, highly efficient monitoring of a system for filtering air flows is achieved, and as a result, an optimized, efficient method of maintaining such a system is carried out.

According to another advantageous configuration of the invention, it is provided that the information regarding a property of the filter fleece can be determined automatically. This information can be determined automatically in this way once or multiple times, regularly or irregularly, or in a user-controlled manner, e.g. initiated on demand or by actuating an actuating element. This makes it even easier to handle a system of this kind, and in particular its maintenance.

According to another aspect, the invention relates to a filter fleece according to the preamble of claim 19.

Proceeding from a known filter fleece having the features of the preamble of claim 19, the object of the invention is to develop the known filter fleece such that it can be advantageously used in a maintenance-friendly system for filtering air flows.

The invention achieves this object by the features of claim 19, in particular by those of the characterizing part, and is accordingly characterized in that an information carrier is on the filter fleece which directly or indirectly carries information regarding a property of the filter fleece, e.g. an article number or a filter type or an identification number.

In order to prevent any repetition and to better understand this claim, reference is made to the preceding comments and the terms used and defined therein. These comments are also applicable, mutatis mutandis (provided that no contradictions arise), to the invention according to the claim described here.

The principle of the invention is essentially to arrange an information carrier on the filter fleece. The information carrier contains direct or indirect information regarding a property of the filter fleece. For example, this information may include an identification number, e.g. in the manner of a serial number. This information may also include an article number, or a color of the filter fleece, information regarding a material or material characteristic of the filter fleece, information regarding the intended purpose of the filter fleece, information regarding the particles that can be filtered out of the air flow by the filter fleece, information regarding the maximum intended service life of the filter fleece, or information regarding the maximum expiry date of the filter fleece, or the like. The information carrier may for example be formed by a sticker, e.g. characterized by a barcode, or may be formed by a sequence of numbers or by an RFID tag or an NFC tag or by another electromagnetic resonant circuit.

The information carrier is advantageously formed such that it does not require its own power source, but instead such that it is designed as an externally excitable resonant circuit, for example.

According to the invention, the information contained in the information carrier can be read out, whether by a sensor on a filter frame, for example, or by an operator using a handset, e.g. after inserting a filter fleece into a filter frame.

According to another aspect, the invention relates to an apparatus according to the preamble of claim 21.

Proceeding therefrom, the object of the invention is to develop known Apparatuses such that they can be used in a largely process-automated system for filtering air flows.

The invention achieves this object by the features of claim 21, in particular by those of the characterizing part, and is accordingly characterized in that a sensor is on the filter frame or on the filter fleece or on a retaining device for the filter fleece for transmitting sensor information regarding a property of the filter fleece, e.g. an article number or a filter type, to a controller of a system for filtering air flows.

According to the invention according to claim 21, a sensor is in particular on the filter frame, for reading out information from an information carrier. The information can be read out directly or indirectly. In particular, the information read out from the information carrier includes information regarding a property of the filter fleece. As a result, information regarding filter fleeces can be detected in a highly automated manner in a system for filtering air flows using a large number of air filters.

In order to prevent any repetition and to better understand this claim, reference is made to the preceding comments and the terms used and defined therein. These comments are also applicable, mutatis mutandis (provided that no contradictions arise), to the invention according to the claim described here.

According to a variant, the sensor is directly on the filter fleece. According to another variant of the invention, the sensor is on a retaining device for the filter fleece.

According to another aspect, the invention relates to a system according to claim 22.

Systems for filtering air flows are known per se and are widespread.

Proceeding from a known system of this kind, the object of the invention is to develop the known system such that simplified documentation is possible.

The invention achieves this object by the features of claim 22 and is accordingly characterized in that a plurality of air filters are provided which each comprise a filter frame, a sensor, which is in particular on the filter frame, and a filter fleece, wherein a controller is provided to which an apparatus for documentation is assigned, wherein information from the sensors regarding the inserted filter fleeces can be received by the controller for forwarding to the apparatus.

The principle of the invention is essentially to provide a system which comprises a controller for receiving and forwarding information to an apparatus for documentation. This information in particular includes information regarding the inserted filter fleeces. This may for example include information as to what types of filter fleeces have been inserted, what service lives of the filter fleeces have already been reached, and what remaining service lives are still left until the next scheduled maintenance interval. The information may also include position data, i.e. information as to the Apparatuses for filtering air flows into which the corresponding filter fleeces have been inserted. Furthermore, the information may include position data as to the regions or locations within a building at which particular air filters are provided or have been inserted. The information may also include status data, i.e. information regarding the current status of filter fleece or a filter. This may for example include the level of soiling or an individual service life of the air filter or a filter fleece.

The controller may receive this information directly from the individual air filters, for example from sensors which are on the corresponding filter frames of the air filters, but the invention also covers the case in which the controller receives the corresponding information indirectly, for example from handsets. Therefore, operators can successively input individual air filters, for example, can read out memory elements of sensors of the individual air filters, for example, and can then transmit this information to the controller successively or in a combined manner using the read-out handset. The invention also covers the case in which the controller receives this information directly from the filter elements wirelessly or in a wired manner.

The apparatus for documentation may be part of the controller or may be assigned thereto, and/or may be connected to the controller. The apparatus for documentation may manage and/or process the received information. The apparatus for documentation may in particular document the received information and keep it available for retrieval. Therefore, it can for example be continuously documented when which air filters or filter fleeces have been replaced. The apparatus for documentation may also be equipped with a maintenance system or may be connected thereto and may consult the documented information in order to optimize maintenance intervals.

In order to prevent any repetition and to better understand this claim, reference is made to the preceding comments and the terms used and defined therein. These comments are also applicable, mutatis mutandis (provided that no contradictions arise), to the invention according to the claim described here.

According to an advantageous configuration of the invention, the information includes information regarding the filter fleeces attached to the individual filter frames and/or information regarding the service lives of the filter fleeces and/or information regarding the level of soiling of individual filter fleeces.

As a result, a system is provided which can then be automated in a simple manner.

The system according to the invention comprises at least one inlet and one outlet. Furthermore, a recirculating device is provided. At least one fan and a fan unit, which ensures that the air flow circulates within the pipe system, are on the recirculating device. The recirculating device may (but does not have to) comprise a heating device and/or a cooling device. In these cases, a heat exchanger is provided which cools or heats a cooled or heated medium in the sense of optimal heat exchange with the air flow that is guided through the heat exchanger. Separators, air driers, air humidifiers, or apparatuses that add constituents to the air flow can also be provided in the recirculating device.

The air-flow inlet may be equipped with one or more air intakes. In the same way, the air outlet may be equipped with one or more air exhausts. The inlet and the outlet may be branched in any manner.

The system according to the invention in particular comprises variants in which air filters are in the region of the air-inlet intakes and/or upstream of a fan or fan unit. These air filters are provided by Apparatuses for filtering air flows which comprise at least one filter frame and at least one filter fleece.

In order to prevent any repetition and to better understand this claim, reference is made to the preceding comments and the terms used and defined therein. These comments are also applicable, mutatis mutandis (provided that no contradictions arise), to the invention according to the claim described here.

According to another aspect, the invention relates to a system according to claim 24.

Proceeding from a known system, the object of the invention is to develop the known system such that improved management of the system is possible.

The invention achieves this object by the features of claim 24.

The principle of the invention is essentially that the controller of the system can receive position data or position information. The position data can be further processed or managed.

Within the meaning of the present patent application, position data are information regarding a location or a position of individual air filters and/or location information regarding individual filter fleeces inserted into air filters.

In addition to information regarding the air filter or information regarding the filter fleece, which for example makes it possible to identify the air filter or to identify the filter fleece, the position data also include information that corresponds to location information of the air filter or location information of the filter fleece. The location information can for example indicate to the controller in what part of a building, on what floor of a building or in what room of a building a particular air filter or filter fleece is positioned. The controller can receive the obtained position data, and can in particular store and further process or forward the data. For example, the above-mentioned apparatus for documentation advantageously consults the position information and processes the information and/or takes it into account during operation of the system.

The information regarding the air filters and/or the information regarding the filter fleeces may for example include information which can be used for identifying an individual air filter or filter fleece or for identifying a type or group of air filters or a type or group of filter fleeces.

The information that can be received by the controller may also include information regarding properties of the air filters and/or information regarding properties of the inserted filter fleeces.

In order to prevent any repetition and to better understand this claim, reference is made to the preceding comments and the terms used and defined therein. These comments are also applicable, mutatis mutandis (provided that no contradictions arise), to the invention according to the claim described here.

According to another aspect, the invention relates to an apparatus according to the preamble of claim 26.

Proceeding from a known apparatus having the features of the preamble of claim 26, the object of the invention is to provide an apparatus which can be advantageously used in a system for filtering air flows.

The invention achieves this object by the features of claim 26 and is accordingly characterized in that an apparatus is on the filter frame, for detecting and/or determining and/or storing and/or transmitting apparatus position data regarding the air filters and/or position data regarding the inserted filter fleeces for assignment to a filter frame and/or filter fleece.

The principle of the invention is essentially that an apparatus for detecting and/or determining position data is on the apparatus. The position data may include information regarding the location or position of the air filter, the filter frame and/or the inserted filter fleece. In an embodiment of the invention, the position data can be determined by the apparatus autonomously or by itself, for example with the aid of GPS information, other location information, markers, and in particular with the aid of relative location information. According to a variant of the invention, the location information can, however, also be input manually, for example by operators, and can be assigned to the air filter, the filter frame or the filter fleece, and can be written into a memory of the apparatus, for example. According to a variant of the invention, for this purpose it is provided, for example, that an operator assigns location information directly to the apparatus using a portable handset, and writes the information into a memory of the apparatus via a wireless connection, such as Bluetooth, RFID or NFC, for example.

In order to prevent any repetition and to better understand this claim, reference is made to the preceding comments and the terms used and defined therein. These comments are also applicable, mutatis mutandis (provided that no contradictions arise), to the invention according to the claim described here.

According to a variant, the apparatus is directly on the filter fleece. According to another variant of the invention, the apparatus is on a retaining device for the filter fleece.

According to a variant of the invention, the apparatus can detect position data. In this variant, position data regarding the air filter or position data regarding the inserted filter fleeces can be determined by the apparatus itself, or can be transmitted to the apparatus by another device.

According to a variant of the invention, position data can be stored by the apparatus.

According to another variant of the invention, position data can be transmitted by the apparatus, e.g. can be transmitted to a controller of an above-described system.

According to another embodiment of the invention, position information can be assigned to a particular filter frame and/or position information can be assigned to a particular filter fleece by the apparatus. This means that, during the installation of air filters or after the installation of filter fleeces, an operator can for example communicate to the apparatus that a particular filter fleece, e.g. a type of filter fleece having a particular date of expiry, is at a particular location within a building. This position information can be written into the apparatus.

The position data can e.g. be transmitted to a controller of an above-described system by the apparatus.

According to another aspect, the invention relates to an apparatus according to the preamble of claim 27.

Proceeding from a known apparatus having the features of the preamble of claim 1, the object of the invention is to develop the apparatus so as to improve its handling.

The invention achieves this object by the features of claim 27, in particular by those of the characterizing part, and is accordingly characterized in that an apparatus is in particular on the filter frame for displaying and/or retrieving which apparatus information regarding the status of the filter fleece.

The principle of the invention is essentially that an apparatus is on the filter frame for displaying or retrieving apparatus status information. The status information includes information regarding the status of the filter fleece. For example, in this case, this may be the above-described information regarding a level of soiling of the filter, information regarding service lives and information regarding remaining service lives until a prescribed maintenance interval. This information regarding the status of the filter fleece can be displayed by the apparatus, or can be retrieved.

This may for example be displayed optically with the aid of an LED or another signal apparatus. For example, a two-color (red/green) LED may be provided, which is actuated by the apparatus such that, whilst the level of soiling of the filter fleece is sufficiently low, a green LED is lit up, and once a threshold value for a level of soiling has been exceeded, and therefore it displays that the filter needs replacing, the LED switches to red. In this way, operators who regularly deal with the maintenance of such air filters or systems comprising air filters can easily visually identify that a filter needs replacing.

Alternatively, the apparatus may provide an acoustic indication, or may output a corresponding warning signal or another item of status information in a different manner.

The invention also covers the case in which the apparatus keeps available information regarding the status of the filter fleece for retrieval. Therefore, a retrieval signal can for example be transmitted by a portable handset, which for example can establish a wireless or wired connection to the apparatus, whereupon the apparatus transmits its current filter status.

According to a variant, the apparatus is directly on the filter fleece. According to another variant of the invention, the apparatus is on a retaining device for the filter fleece.

In order to prevent any repetition and to better understand this claim, reference is made to the preceding comments and the terms used and defined therein. These comments are also applicable, mutatis mutandis (provided that no contradictions arise), to the invention according to the claim described here.

According to an advantageous configuration of the invention, the information regarding the status of the filter fleece can be retrieved and/or displayed on demand or alternatively automatically. As a result, particularly convenient handling is achieved.

According to another advantageous configuration of the invention, the information regarding the status of the filter fleece can be measured and/or detected and/or determined and/or received and/or stored and/or transmitted by the apparatus.

Status information, i.e. information that informs or can inform of a current state or status of the filter fleece, can be measured by the apparatus in a variant of the invention. Such a measurement can be initiated by the apparatus and for example can be carried out with the aid of the above-described measurement methods, such as acoustic, optical, inductive, capacitive, mechanical, or electromagnetic measurement methods, moisture measurement methods or other measurement methods, for example with the aim of measuring the level of soiling.

According to a variant of the invention, the information regarding the status of the filter fleece can be detected by the apparatus. Such detection may also include a measurement being taken, for example by an operator, and the measurement results of this measurement being directly transmitted to the apparatus, for example by a portable handset.

According to a variant of the invention, the information regarding the status of the filter fleece can be determined, i.e. for example not measured, but ascertained in a different way, e.g. indirectly, for example taking into account service lives or other specified lengths of time. Lastly, in a variant of the invention, the information regarding the status of the filter fleece can also be received by the apparatus, for example by an external measuring device. Lastly, in a variant of the invention, it is provided that the information regarding the status of the filter fleece can be stored. This information can be stored directly in the apparatus or in a memory assigned to the apparatus.

According to another alternative of the invention, the information regarding the status of the filter fleece can be transmitted by the apparatus, for example to an external portable handset, or to a controller of an above-described system.

According to another aspect, the invention relates to an apparatus according to claim 30.

Apparatuses for filtering air flows are known. The Apparatuses routinely comprise a filter frame and a filter fleece arranged, in particular detachably arranged, on the filter frame.

Proceeding from a known apparatus of the above-described type, the object of the invention is to improve the known apparatus.

The invention achieves this object by the features of claim 30.

The principle of the invention is essentially that of providing an apparatus in which an apparatus that can detect information regarding the status of the filter fleece is on the filter frame. The apparatus comprises a power source and electronic components, which are outside an inner circumferential contour of the filter frame. These elements do not project into the clear width of the filter fleece through which the air flow to be filtered is intended to pass.

The apparatus further comprises a measuring head. This measuring head, the actual sensor head, projects inwards beyond the inner circumferential contour of the filter frame and is therefore within the inner circumferential contour. The measuring head is mechanically and/or electrically connected, optionally also via a wireless connection, to the electronic components or the power source of the apparatus.

According to a variant of the invention, the measuring head can be on a retaining device for the filter fleece. The retaining device can be used to fix the filter fleece relative to the filter frame.

In order to prevent any repetition and to better understand this claim, reference is made to the preceding comments and the terms used and defined therein. These comments are also applicable, mutatis mutandis (provided that no contradictions arise), to the invention according to the claim described here.

According to another aspect, the invention relates to an apparatus according to claim 33.

This invention achieves the object of developing a known apparatus such that it is improved.

The invention achieves this object by the features of claim 33.

An apparatus can be on the filter frame for measuring apparatus information regarding the status of the filter fleece.

According to a variant, the apparatus is directly on the filter fleece.

According to another variant of the invention, the apparatus is on a retaining apparatus for the filter fleece.

Other advantages become apparent from the dependent claims, which have not been cited, as well as from the following description of the embodiments shown in the drawings, in which:

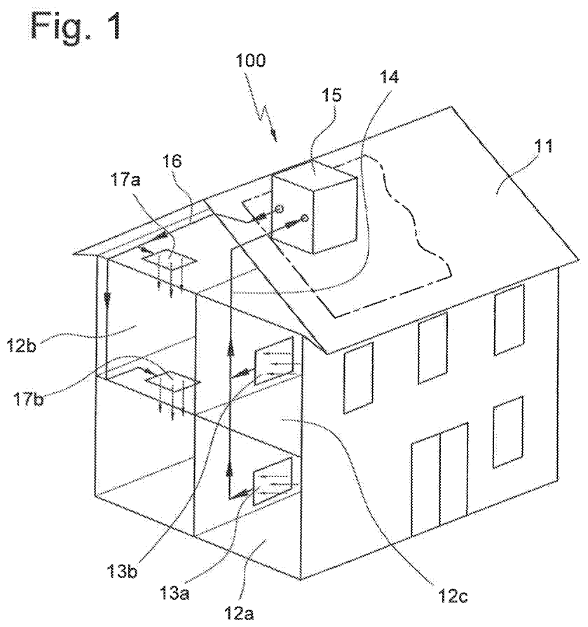

FIG. 1 is a schematic, perspective, partially sectional view of a building comprising an embodiment of a system according to the invention for filtering air flows,

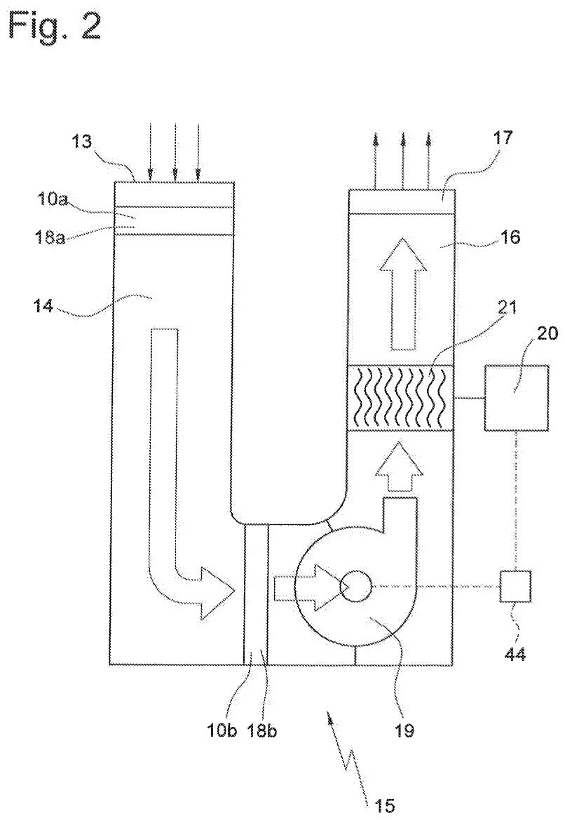

FIG. 2 is a schematic diagram for explaining the air flows in a system according to the invention for filtering air flows comprising two air filters shown by way of example,

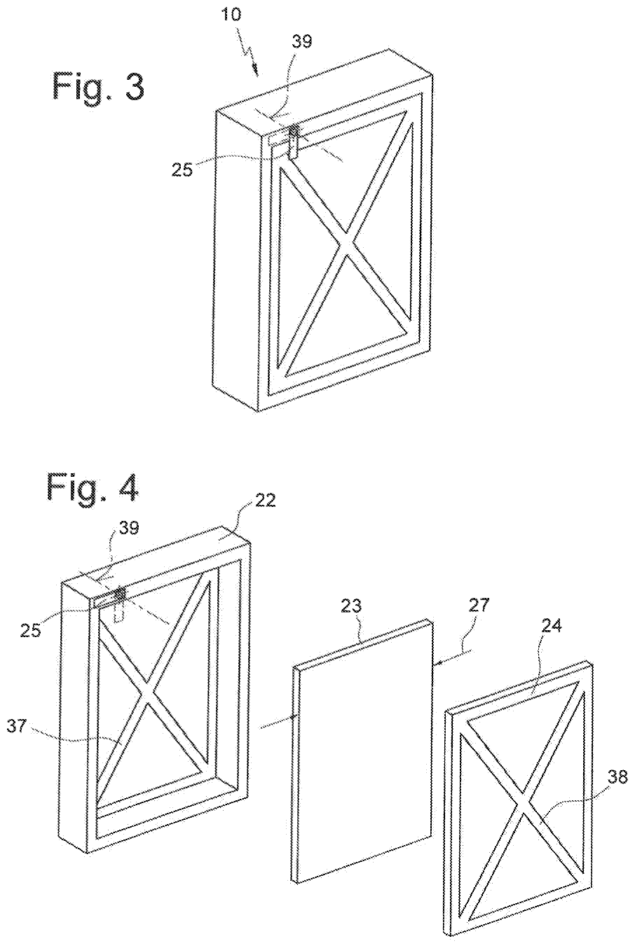

FIG. 3 is a perspective schematic view of an apparatus according to the invention for filtering air flows, comprising a filter frame, a replaceable filter fleece, and a retaining device, as well as a rotatable latch element in a closed position,

FIG. 4 is an exploded view of the air filter from FIG. 3,

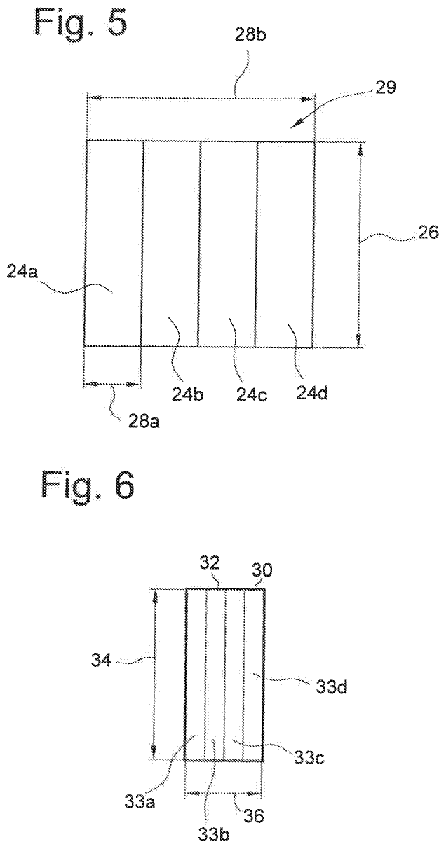

FIG. 5 shows a plurality of filter fleeces beside one another in a non-compressed state,

FIG. 6 shows the plurality of filter fleeces according to FIG. 5 in a compressed state, surrounded by evacuated transport packaging according to the invention,

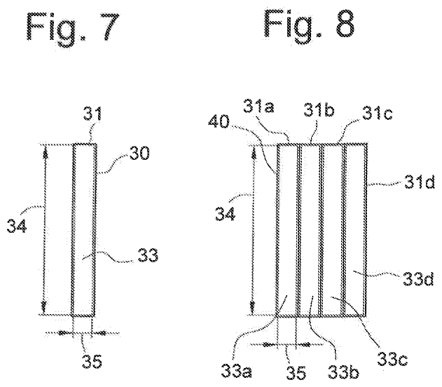

FIG. 7 shows a single compressed filter fleece surrounded by evacuated transport packaging, according to the invention,

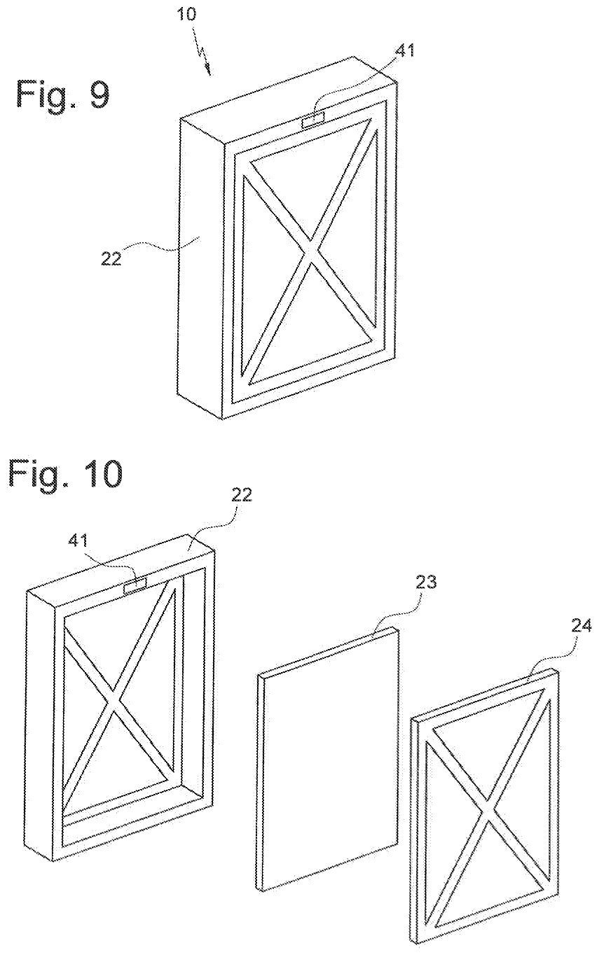

FIG. 8 shows a plurality of filter fleeces which are each individually surrounded by evacuated transport packaging according to the invention, and are fastened to one another by a retaining device,

FIG. 9 shows another embodiment of an apparatus according to the invention for filtering air flows in a view according to FIG. 3, with a sensor being on the filter frame,

FIG. 10 is a schematic exploded view, similar to FIG. 4, of the embodiment from FIG. 9,

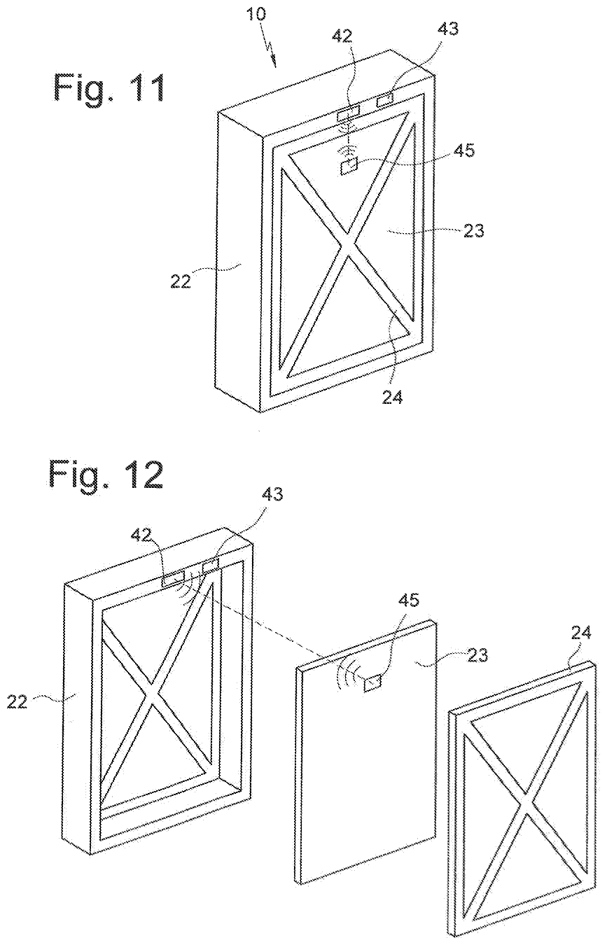

FIG. 11 shows an embodiment of an apparatus according to the invention comprising a sensor for detecting information regarding a property of the filter fleece, in a view according to FIG. 3,

FIG. 12 is an exploded view of the embodiment from FIG. 11,

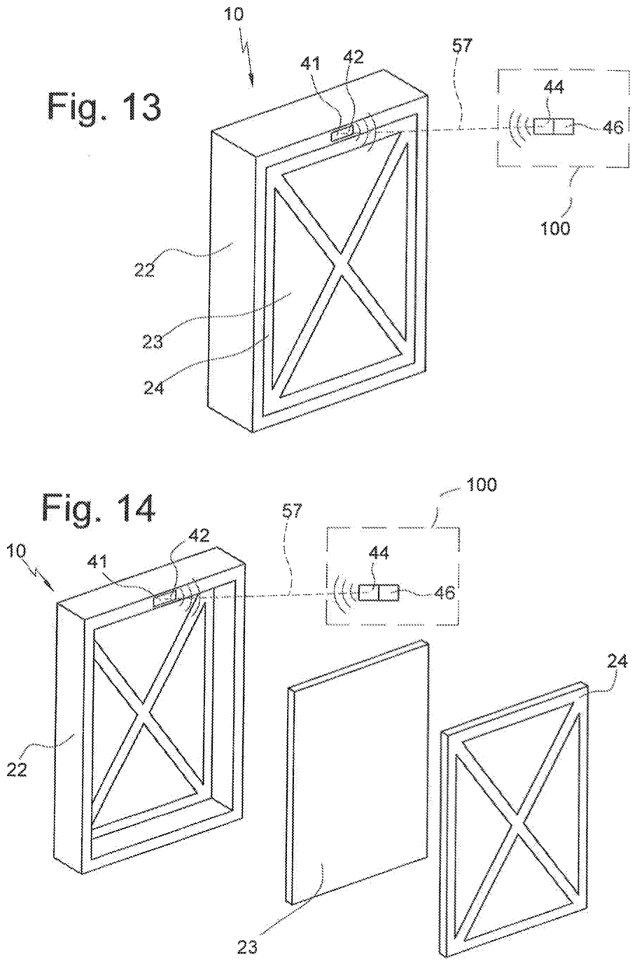

FIG. 13 shows an embodiment of an apparatus according to the invention, which comprises a sensor for transmitting information to a controller of a system (not shown in detail) according to the invention for filtering air flows, in a view comparable to FIG. 3,

FIG. 14 is an exploded view of the embodiment from FIG. 13,

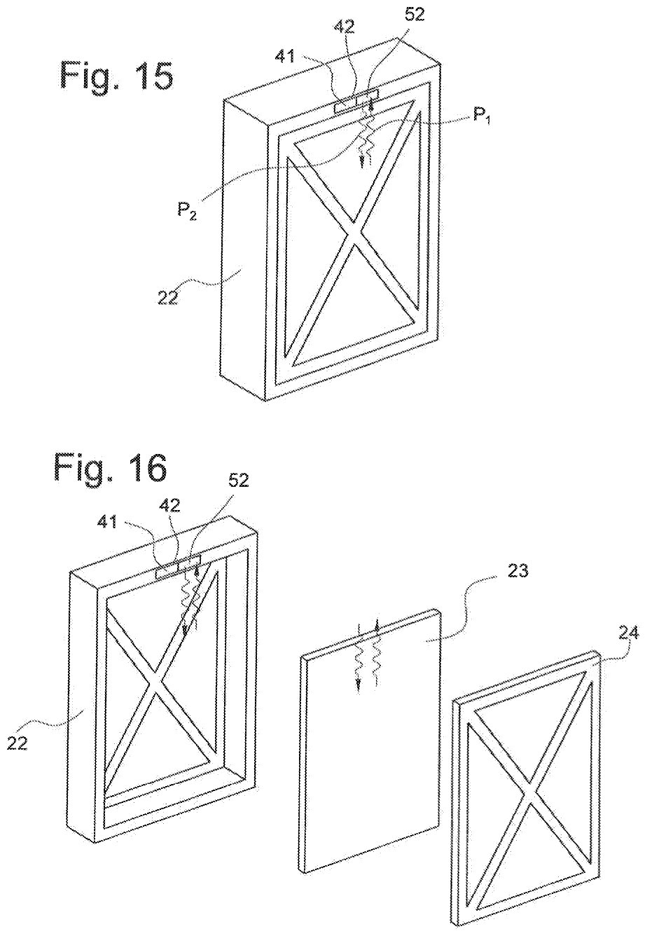

FIG. 15 shows an embodiment of an apparatus according to the invention comprising a sensor for determining a status of the filter fleece, in a view according to FIG. 3,

FIG. 16 is an exploded view of the embodiment from FIG. 15,

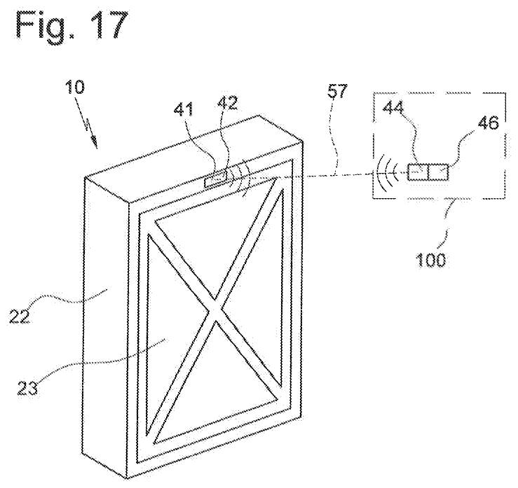

FIG. 17 shows an embodiment of an apparatus according to the invention in a view according to FIG. 3, with a sensor being on the apparatus for transmitting information regarding a property of the filter fleece to a controller of a system for filtering air flows,

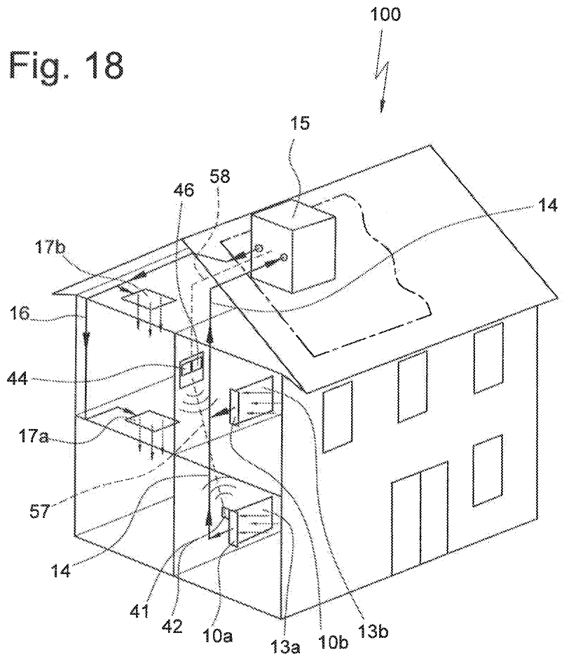

FIG. 18 shows an embodiment of system according to the invention in a view according to FIG. 1 in an arrangement within a building, wherein information can be transmitted from an apparatus on the air filters to a controller of the system, wherein the information can include data regarding properties of the filter or filter fleece and/or information regarding the status of the filter or filter fleece and/or can include information which can include position data for the filter or filter fleece,

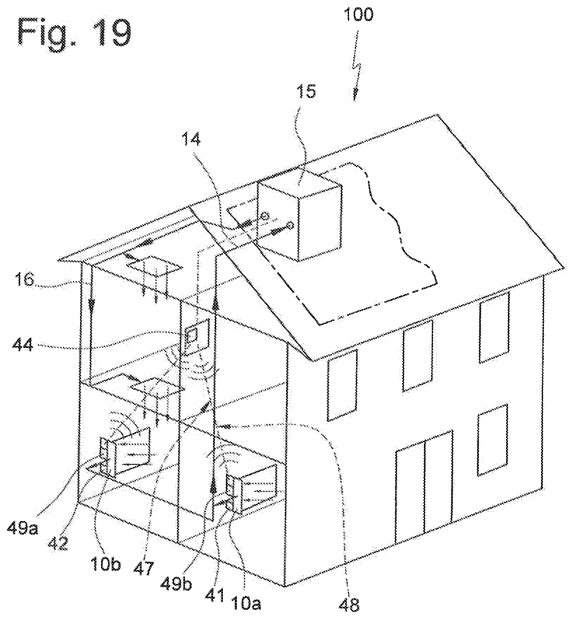

FIG. 19 shows an embodiment of a system according to the invention in a view according to FIG. 18, wherein the controller of the system receives position data from a plurality of different air filters,

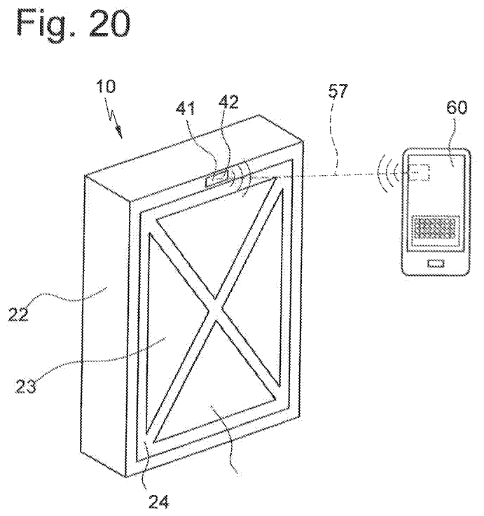

FIG. 20 shows another embodiment of an apparatus according to the invention in a view according to FIG. 3, wherein an apparatus which can receive information from a portable handset or transmit information thereto is on a filter frame of the apparatus,

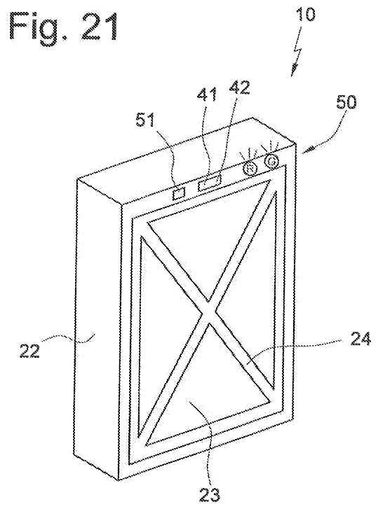

FIG. 21 shows an embodiment of an apparatus according to the invention in a view according to FIG. 3, wherein a display apparatus that displays or communicates information regarding the status of the filter or filter fleece or keeps the information available for retrieval is on the apparatus, and

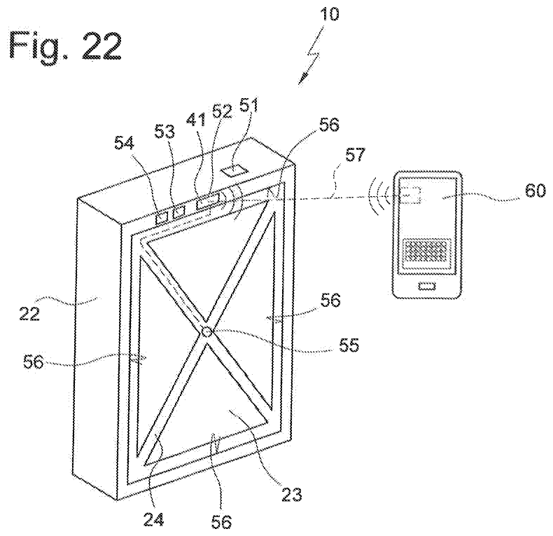

FIG. 22 shows another embodiment of an apparatus according to the invention in a view according to FIG. 3, wherein a sensor which comprises electronics and/or a power-supply source on the filter frame and a measuring head approximately centrally based on the clear width of the filter fleece is on the filter frame of the apparatus.

Embodiments of the invention are described by way of example in the following description of the figures, also with reference to the drawings. Here, for the sake of clarity, even if different embodiments are involved, identical or comparable parts or elements or regions have been denoted by identical reference signs, sometimes with the addition of lower-case letters.

Features that are only described, set out or disclosed in relation to one embodiment can also be provided in any other embodiment of the invention within the scope of the invention. Even if they are not shown in the drawings, such amended embodiments are covered by the invention.

All the features disclosed are essential to the invention per se. The content of the disclosure of the associated priority documents (copy of the previous application) and the cited documents and the prior art Apparatuses described are hereby incorporated into the disclosure of the application in their entirety, also for the purpose of incorporating individual features or a plurality of features of the subjects disclosed therein into one or more claims of the present application. Even if they are not shown in the drawings, such amended embodiments are also covered by the invention.

An embodiment of a system 100 according to the invention for filtering air flows is shown schematically in FIG. 1:

This figure schematically shows a building 11 comprising a plurality of rooms 12a, 12b, 12c. The system 100 for filtering air flows comprises a schematically shown inlet 14, which leads to a recirculating unit 15, out of which an outlet 16 leads. The inlet 14 comprises two intakes 13a, 13b shown by way of example. The outlet comprises two exhausts 17a, 17b shown by way of example.

As shown schematically in FIG. 2, the recirculating unit 15 may for example comprise a fan 19, a heater 20 and a heat exchanger 21. A cooling unit (not shown), which cools the air flow, may also be provided instead of a heater 20.

As shown in FIG. 1, the intake 13, 13a, 13b may for example be in or on a wall of a room 12a in the building and may e.g. be provided by an air intake grating, to which an air filter 10a, 18a, shown schematically in FIG. 2, is directly attached. The air is guided to the fan 19 in the direction of the arrow in FIG. 2. Another air filter 10b, 18b may optionally be provided directly on the input side of the fan 19. The fan 19 ensures that the air circulates within the pipe system 14, 16.

Depending on the number of rooms in the building, the number of intakes 13, 13a, 13b and also the number of exhausts 17, 17a, 17b can be selected as desired. The inlets 14 and outlets 16 may have any cross section, for example a square or rectangular cross section, and may be formed so as to be substantially closed except for the intakes and exhausts.

An embodiment of an air filter 10a, 10b, 18a, 18b is shown in detail in FIGS. 3 and 4:

According to the present patent application, such an air filter 18a, 18b is also referred to as an apparatus 10 for filtering air flows.

According to FIGS. 3 and 4, an apparatus 10 according to the invention comprises a filter frame 22, comprising an insertion compartment for a filter fleece 23, and a retaining device 24. According to FIG. 4, the filter frame 22 comprises an e.g.

cross-like retaining structure 37, which prevents the mat-like filter fleece 23 from falling out of the frame.

The retaining device 24 also comprises an e.g. substantially cross-like complementary structure 38, which prevents the filter fleece 23 from falling out of the frame in the rearward direction.

Instead of a cross-like structure 37, 38 as shown in the drawings, both the filter frame and the retaining device 27 may also have any other geometric design.

It should be noted that a latch element 25 is shown by way of example in FIGS. 3 and 4, which is pivotable about an axis 39. FIG. 4 shows the latch by way of solid lines in an open position in which the filter fleece 23 and the retaining device 24 can be inserted into the frame. After they are inserted, the latch 25 can be pivoted by approximately 90° anticlockwise about the pivot axis 39 out of the open position according to FIG. 4 into the closed position according to FIG. 3, and can secure the retaining element 24 on the filter frame 22.

The construction described is merely an example of a plurality of configurations of filter frames 22 and retaining devices 24 that are possible and acceptable in the context of the invention.

According to FIG. 5 to 8, different examples of transport packaging and compressed filter fleeces will now be set out:

According to FIG. 4 in connection with FIG. 5 to 7, it should first be made clear that a filter fleece 23 for insertion into a filter frame 22 has a height 26, a width 27 and a thickness or wall thickness 28a.

If a filter fleece 23 of this kind is in transport packaging 30 so as to be compressed, in particular evacuated, according to the invention, according to FIG. 7 a dimension of the thus compressed filter fleece results such that the filter fleece only still has a height 34 that is considerably less than the height 26 of the non-compressed filter fleece, and has a thickness or wall thickness 35 that is considerably less than the thickness 28a of the non-compressed filter fleece. The width B of the compressed filter fleece 33 is considerably reduced compared with the width 27 of the non-compressed filter fleece (FIG. 4).

According to the embodiment in FIG. 7, the transport packaging 30 can be provided by a transparent, airtight plastics film.

In this respect, FIG. 7 shows a single fleece comprising a single item of transport packaging 31.

FIG. 8 shows an embodiment in which a plurality of filter fleeces 33a, 33b, 33c, 33d are each individually compressed and are each surrounded by a single item of transport wrapping 31a, 31b, 31c, 31d. In addition, in the embodiment in FIG. 8, a fastening device 40 is provided which fastens the individual, compressed filter fleeces 33a, 33b, 33c, 33d to one another. This fastening device 40 may for example be formed by another plastics envelope or by adhesive tape or another fastening means.

The embodiment in FIG. 6 shows a plurality of compressed filter fleeces:

While FIG. 5 shows a plurality 29 of non-compressed filter fleeces 24a, 24b, 24c, 24d having a total thickness 28b, FIG. 6 shows a plurality of compressed filter fleeces 33a, 33b, 33c, 33d of which the total thickness 36 is considerably reduced by comparison. According to the embodiment in FIG. 6, the individual filter fleeces 33a, 33b, 33c, 33d are together surrounded by transport packaging 30, known as a transport multi-pack 32. This may advantageously also be airtight, and may for example be provided by a transparent plastics film.

The embodiments in FIGS. 7, 8 and 9 show that the volume requirements of such compressed filter fleeces 33a, 33b, 33c, 33d are considerably reduced compared with non-compressed filter fleeces 24a, 24b, 24c, 24d. As a result, the space required both for transport and storage can be reduced.

If the filter fleeces are intended to be replaced on site, the transport packaging just has to be opened. The filter fleece can relax from the compressed state into the non-compressed state and can be directly fixed to the filter frame.

According to the embodiment in FIG. 9, an apparatus for filtering air flows according to claim 6 is denoted by reference sign 10 in its entirety.

As in the preceding embodiments, an apparatus of this kind comprises a filter frame 22 and a filter fleece 23.

A retaining device 24 may optionally be provided, which secures the filter fleece 23 to the filter frame 22. A latch (not shown in FIGS. 9 and 10) may optionally also be provided. Of course, other latch elements can also be covered by the invention.

According to the embodiment in FIGS. 9 and 10, a sensor 41 is on the filter frame 22. The sensor may be designed to receive information from the filter fleece 23 or to receive information regarding the filter fleece, and/or to receive or obtain information regarding the status of the filter fleece, e.g. the level of soiling or the service life.

In a variant of the invention, the sensor 41 may also be designed to transmit information to a control room or controller 44 of the system 100.

The special feature of the embodiment in FIGS. 9 and 10 is that the sensor 41 is securely on the filter frame 22 and remains there when a filter fleece 23 is changed and is replaced with a new filter fleece 23. In this respect, the only consumable material is the filter fleece 23. The filter frame 22 and the sensor 41 attached thereto can also be reused after a new filter fleece 23 is reattached. This ensures that an apparatus 10 according to the invention for filtering air flows is provided in a sustainable and beneficial manner.

According to the embodiment in FIG. 11, an apparatus according to the invention for filtering air flows is intended to be explained, which again comprises a filter frame 22 and a filter fleece 23. In this embodiment too, a retainer 24 is provided, which can detachably fix the in particular replaceable filter fleece 23 to the filter frame 22. A latch (shown in some of the preceding embodiments) may optionally also be provided.

According to the embodiments in FIGS. 11 and 12, the apparatus 10 comprises a sensor 42. In one embodiment of the invention, the sensor 42 may also be in addition to the above-described sensor 41, may also be connected to a sensor 41 of this kind, or may also form a unit together with a sensor 41 of this kind.

A memory element 43 may be assigned to the sensor 42, in particular may be connected to the sensor 42, or may be an integral part of the sensor 42.

The sensor 42 is designed to determine or detect information regarding a property of the filter fleece 23.

A property of the filter fleece 23 may for example be an identification number of the filter fleece, a serial number, an article number, a product category number, information regarding the material used for the filter fleece, or other information regarding the filter fleece. For example, the information may also include a note as to what types of particles the filter fleece is supposed to be used for, what areas of application are covered, what expiration dates or what manufacturing date the filter fleece 23 has, what the prescribed service life of the filter fleece 23 is, etc.

The information may for example be directly detected optically, electromagnetically, inductively, capacitively or in another suitable way by the sensor 42. Therefore, for example, as shown in the embodiments in FIGS. 11 and 12, an information carrier 45 may be on the filter fleece 23 itself. For example, the information carrier 45 may be formed by an RFID tag, and the sensor 42 may in turn have an RFID reader. Other technologies for reading out information stored in the information carrier 45 by the sensor 42 are also covered by the invention, such as NFC, Bluetooth, WLAN, etc.

In the simplest case, the information carrier 45 on the filter fleece 23 is not provided with its own power source, but instead either an externally excitable resonant circuit or an optically readable element, such as a barcode, a number or the like, which can be optically read out by the sensor 42, are provided.

The information from the information carrier 45 can be input by the sensor 42 when the filter fleece 23, in particular once the filter fleece has been replaced in accordance with a prescribed service life, is brought close enough to the filter frame or has been inserted into the filter frame 22. The sensor 42 (not shown in the drawings) may also have a trigger button or switch which, when actuated, initiates the input process.

In another embodiment of the invention, information regarding the filter fleece 23 is detected by the sensor 42 not directly with the aid of a direct operative connection between the filter fleece 23 and the sensor 42, but instead with the aid of an operator. For example, a technician who is replacing a filter fleece 23, e.g. with the aid of a handset, e.g. a mobile telephone, in particular with the aid of suitable software, can communicate to the sensor 42 that a new filter fleece 23 has been inserted into the filter frame 22 and optionally also what type of filter it is, etc.

In any case, the sensor 42 is capable of detecting information regarding the filter fleece 23.

Advantageously, this information can also be stored in the memory element 43.

According to the embodiment in FIGS. 13 and 14, it is explained that the sensor 42 and/or another suitable sensor 41 can transmit information from the apparatus 10 to a controller 44 of a system 100 for filtering air flows.

FIG. 13 indicates a connection line 57 which connects the sensor 41, 42 to the controller 44. The connection line 57 may be a physical connection line, i.e. a cable or wire, or may be a radio link, for example using WLAN, Bluetooth, NFC, GSM or another suitable radio protocol. Optical or acoustic connection links 57 are covered by the invention.

As indicated in FIG. 18, for example, the controller 44 can control the entire ventilation process and, for example, the heating apparatus, cooling apparatus, humidifiers, fan, and recirculating unit 15. The controller 44 may in particular be designed to manage maintenance information, initiate maintenance processes, or communicate to external companies or persons that certain filters 10a, 10b require maintenance.

To do this, information can be received by the sensor 41, 42 from the controller 44 using the connection lines 57. The received information may include information regarding a property of the filter or filter fleece and/or information regarding the status of the filter fleece and/or information regarding a position of the filter 10 or filter fleece 23.

The invention also covers the case in which the connection line 57 is not provided directly between the sensor 41, 42 and the controller 44, in the sense of a direct connection, but instead is provided indirectly, by inserting an additional element. This additional element may for example also be a portable, e.g. handheld, mobile electronic device, e.g. a mobile phone. In this intermediary connection, an item of the above-mentioned information can be read out e.g. from the sensor 41, 42 by the mobile device, and can later be transmitted from the mobile device to the controller 44.

According to the embodiments in FIGS. 15 and 16, Apparatuses according to the invention will now be described which comprise a sensor 41, 42 for determining a level of soiling or a service life of the filter fleece 23. To do this, the sensor 41, 42 may comprise an apparatus 52 for status detection or may be connected to such an apparatus.

At this point, it should be noted that such an apparatus 52 for status detection may also be integrated in the sensor 41 and/or the sensor 42. The invention in particular also covers embodiments not shown in the drawings which comprise such a sensor 41 or sensor 42 in which an apparatus for status detection is integrated.

By way of example, FIGS. 15 and 16 show measurement arrows P1 and P2 which are intended to indicate that the sensor 41, 42 or the apparatus 52 can emit a measured signal (P1) and can receive a measured signal (reflection signal P2 or measured signal P2). The measurement arrows P1 and P2 are intended to indicate that e.g. an optical, electromagnetic, capacitive or inductive measurement or a moisture measurement or a mechanical measurement or another suitable measurement can be carried out in order to establish whether a certain level of soiling or clogging of the filter has been reached. As the filter fleece is operated with an increasing service life, increasing quantities of particles are of course deposited in the filter fleece 23. Depending on the type of particles to be filtered and depending on the type of filter fleeces 23 used, these particles may eventually result in optimized air filtering no longer being guaranteed. The maximum service life of the filter fleece 23 has then been reached, and the filter fleece needs to be replaced.

The status of the filter fleece 23 can be determined or detected regularly or irregularly, in an automated manner or automatically, or so as to be initiated by an operator.

FIG. 17 shows an embodiment of an apparatus 10 according to the invention in which position information can be transmitted from a sensor 41, 42 to a controller 44 of a system 100 via an operative connection 57.

According to the embodiment in FIG. 18, such a system 100 according to the invention is shown, which comprises an inlet 14, an outlet 16, a plurality of air intakes 13a, 13b and a plurality of air exhausts 17a, 17b.

Apparatuses 10a, 10b for filtering air can be in the region of the air intakes 13a, 13b.

Another air filter 10 may in particular also be in the region of the recirculating unit 15 upstream of a fan that is there but is not shown in FIG. 18.

The system 100 may have a controller 44 which can be connected to the recirculating unit 15 via an operative line 58. The controller 44 may for example ensure cooling or heating of the air flow and the humidifying or drying thereof, and may also drive or control a unit within the recirculating unit 15, e.g. also a fan that is there but is not shown in FIG. 18.

In the embodiment in FIG. 18, the controller 44 receives information from the sensors 41, 42 of the air filter 10a via the connection line 57. This may for example be information regarding properties of the air filter 10a or properties of the filter fleece 23 positioned in the air filter 10a and/or may be information regarding the status of the air filter 10a or the status of the filter fleece of this air filter 10a, and/or may be position data of the air filter 10a or the associated filter fleece 23.

This information is received by the controller 44. The controller 44 is connected to the apparatus 46 for documentation. Together with the apparatus 46 for documentation, the controller 44 can process and manage the received information regarding the inserted filter fleeces 23 and can take the information into account when controlling filtering processes and carrying out maintenance processes.

According to the embodiment in FIG. 19, a system 100 is provided which receives and/or manages and/or processes position data. The system 100 comprises a recirculating unit 15, to which an air inlet 14 leads, and out of which an air outlet 16 leads. The system 100 comprises a plurality of air filters 10a, 10b. A controller 44 of the system 100 can manage position data.

To do this, a sensor 41, 42 or an apparatus 49a, 49b is preferably on each apparatus 10a, 10b for filtering air flows for detecting and/or determining and/or storing and/or transmitting and/or assigning apparatus position data. Position data are data which directly or indirectly provide information regarding a location of the apparatus 10a, 10b or a location of the filter frame 22 or a location of a filter fleece 23. This may for example include absolute location information i.e. for example indicating that a certain apparatus 10a is located in a certain room on a certain floor of a certain building, or relative location information for example indicating that a certain air filter 10a is located in spatial proximity to another air filter 10b.

As shown by the dashed line 47, which interconnects a sensor 41, 42 and the controller 44 in each case, this position data and position information can be transmitted from the sensor 41, 42 to the controller.

At the same time or separately, property information 48, i.e. information regarding properties of the air filter 10a, 10b or information regarding the properties of the filter fleeces 23 inserted and used therein, can also be transmitted via this connection line, which in turn can be designed wirelessly or in a wired manner or optically.

The controller 44 can interlink this information and/or manage this information in an interlinked manner. In this respect, the controller 44 knows where which air filter is located, what type of air filter has been inserted, and when it is necessary to replace a filter. Advantageously, the controller 44 also receives status information regarding the filters and, in this respect, knows what level of soiling or clogging a particular air filter 10a, 10b has at a particular point in time.

An apparatus 49a, 49b which can determine position data can be in a single apparatus 10a, 10b. To do this, for example known methods for position detection can be used, for example using GSM information and position information.

The invention also covers the case in which the apparatus 49a, 49b for information detection can store position data. The invention also covers the case in which the apparatus 49a, 49b for position-data detection makes it possible to assign position information to a particular filter frame 22 or to a particular filter fleece 23. For example, assigning position information in this way can also be carried out with the aid of an operator and/or a mobile electronic device.

According to the embodiment in FIG. 21, an apparatus 10 according to the invention for filtering air flows is explained, which comprises a filter frame 22 and a filter fleece 23 and optionally also a retaining device 24. The special feature of this device is that an apparatus 50 is provided for displaying or retrieving information regarding the status of the filter fleece 23. To do this, a sensor 41, 42 may be provided which, similarly to the above-described embodiments, displays or detects information regarding the status of the filter fleece 23.

Preferably, regular or irregular measurement can be used to establish whether a certain level of soiling of the filter fleece 23 has been reached.

The apparatus 50, which comprises a display for the status information, can be connected to the sensor 41, 42. The display apparatus 50 may for example comprise one red and one green LED or a single color-changing LED. As long as the level of soiling of the filter fleece 23 is not so high that it is necessary to replace the filter fleece, the green LED is lit up. When the level of soiling increases above a threshold value, the red LED lights up and indicates to an operator that it is necessary to replace the filter fleece 23.

Of course, a display apparatus 50 of the type described is only useful in those Apparatuses 10 which are directly visible to an operator. The display apparatus 50 can be provided at a suitable point, in particular on the frame 22 of the filter, which is easily visually accessible.

The apparatus 10 according to the invention may optionally or additionally also be provided with a request apparatus 51 for requesting status information. This request apparatus 51 may likewise be connected to the sensor 41, 42, and this is not shown in FIG. 21. The status information may for example be retrieved with the aid of a handset 60 shown schematically in FIG. 21. Therefore, when the handset 60 is brought close enough to the request apparatus 51, an operator can read out the status information wirelessly or optionally also in a wired manner.

In an alternative configuration of the invention, the display apparatus 50 is designed such that the status information is permanently displayed, and therefore the LED is always lit up in green or red. In an alternative configuration of the invention, an actuating element (not shown in FIG. 21), e.g. a switch, is provided which prompts the display apparatus 51 to produce a display as a result of being actuated.

According to the embodiment in FIG. 22, another aspect according to the invention is illustrated:

FIG. 22 shows an embodiment of an apparatus 10 according to the invention in which an apparatus 41, 42 is for determining information regarding the status of a filter fleece. To do this, the apparatus 41, 42 in particular comprises a power source 53, e.g. a battery, which is only indicated schematically, and respectively indicated electronic components 54. According to the embodiment in FIG. 2, these components are directly on the frame 22 and do not project inwards beyond the inner contour 56 of the frame. The apparatus 52 for status detection further comprises a measuring head 55, however, which takes a measurement in order to obtain status information. This measuring head 55 is compact and projects inwards beyond the inner circumferential contour 56 of the filter frame and is in particular within this inner circumferential contour 56. In the embodiment in FIG. 22, the measuring head 55 is centrally within the clear width of the filter fleece 23.

Advantageously, the measuring head 55 may be on a retaining device 24, which fixes a filter fleece relative to the filter frame 22.

Because only the measuring head 55 is within the clear width of the filter fleece 23 in the apparatus 52, on one hand, the measurement can be taken at an advantageous location, and on the other hand, the air flow through the filter is not impaired or is only very slightly impaired.

1. An apparatus for filtering air flows, comprising a filter frame, a replaceable filter fleece, and a retaining device that can fix the filter fleece to the filter frame, wherein the filter fleece is in transport packaging so as to be compressed and evacuated.

2. A filter fleece for an apparatus for filtering air flows apparatus according to claim 1, wherein the filter fleece is in transport packaging so as to be compressed and evacuated.

3. A plurality of filter fleeces according to claim 2, wherein the plurality of filter fleeces are together surrounded by evacuated transport packaging.

4. A plurality of filter fleeces according to claim 2, wherein the individual filter fleeces of the plurality of filter fleeces are each individually surrounded by evacuated transport packaging and are fastened to one another.

5. A method of providing at least one filter fleece for an air filter according to claim 2, comprising the following steps:
a) producing a filter fleece,
b) surrounding the filter fleece with transport packaging such that the filter fleece can be stored and transported in a compressed manner and under vacuum,
c) transporting the compressed fleece surrounded by the transport packaging to the point of use, and opening the transport packaging.

6. An apparatus for filtering air flows , according to claim 1, comprising a filter frame and a replaceable filter fleece, wherein the filter fleece can be detachably fixed to the filter frame, by a retaining device, wherein a sensor is on the filter frame or on the filter fleece or on a retaining device for the filter fleece.

7. The apparatus according to claim 6, wherein a property of the filter fleece can be detected and/or determined by the sensor.

8. The apparatus according to claim 6, wherein a property of a replaced filter fleece that has been or is to be reattached to the filter frame can be detected and/or determined by the sensor.

9. The apparatus according to claim 6, wherein a status of the filter fleece can be detected and/or determined by the sensor.

10. The apparatus according to claim 6, wherein information can be transmitted to a controller of a system for filtering air flows by the sensor and/or with the aid of the sensor.

11. The apparatus according to claim 6, wherein the sensor is securely on the filter frame.

12. The apparatus according to claim 6, wherein the sensor remains in an arrangement position on the filter frame while a filter fleece is being replaced.

13. The apparatus for filtering air flows according to claim 1, comprising a filter frame and a filter fleece arranged, detachably arranged, on the filter frame, wherein a sensor is on the filter frame or on the filter fleece or on a retaining device for the filter fleece, for detecting and/or determining sensor information regarding a property of the filter fleece.

14. The apparatus according to claim 13, wherein a memory element, in which the information regarding the property of the filter fleece can be stored, is assigned to the sensor.

15. The apparatus according to claim 13, wherein a status of the filter fleece, level of soiling or a service life of the filter fleece, can be determined by the sensor.

16. The apparatus according to claim 13, wherein information can be transferred to a controller of a system for filtering air flows by the sensor.

17. The apparatus according to claim 13, wherein the filter fleece is designed to be replaceable.

18. The apparatus according to claim 13, wherein the information regarding the property of the filter fleece can be automatically determined.

19. A filter fleece for arranging on a device for filtering air flows according to claim 1, wherein an information carrier is on the filter fleece which directly or indirectly carries information regarding a property of the filter fleece.

20. The filter fleece according to claim 19, wherein the information on and/or from the information carrier can be read out by a sensor which is on a filter frame of an apparatus for filtering air flows.

21. The apparatus according to claim 1, comprising a filter frame and a filter fleece detachably arranged, on the filter frame, wherein a sensor is on the filter frame or on the filter fleece or on a retaining device for the filter fleece for transmitting sensor information regarding a property of the filter fleece.

22. A system for filtering air flows, comprising a recirculating apparatus, an air inlet and an air outlet, wherein a plurality of air filters are provided which each comprise a filter frame, a sensor, which is on the filter frame or on the filter fleece or on a retaining device for the filter fleece, and a filter fleece, wherein a controller is provided to which an apparatus for documentation is assigned, wherein information from the sensors regarding the inserted filter fleeces can be received by the controller for forwarding to the apparatus.

23. The system according to claim 22, wherein the information includes information regarding the filter fleeces on the filter frame and/or information regarding the service lives of the inserted filter fleeces.

24. The system for filtering air flows according to claim 22, comprising a recirculating apparatus, an air inlet and an air outlet, wherein a plurality of air filters are provided which each comprise a filter frame and a filter fleece, wherein a controller is provided which manages information regarding the air filters and/or inserted filter fleeces, wherein the information includes position data regarding the air filters and/or position data regarding the inserted filter fleeces.

25. System according to claim 24, wherein the information includes data regarding properties of the filter fleeces on the filter frame and/or data regarding the service lives of the inserted filter fleeces.

26. The apparatus for filtering air flows according to claim 1, comprising a filter frame and a filter fleece detachably arranged, on the filter frame, wherein an apparatus is on the filter frame or on the filter fleece or on a retaining device for the filter fleece for detecting and/or determining and/or storing, and/or determining position data regarding the point of use of the inserted filter fleeces and for assigning position information assigned to a filter frame and/or filter fleece.

27. The apparatus for filtering air flows according to claim 1, comprising a filter frame and a filter fleece detachably arranged on the filter frame, wherein an apparatus is on the filter frame or on the filter fleece or on a retaining apparatus for the filter fleece for displaying and/or retrieving apparatus information regarding the status of the filter fleece.

28. The apparatus according to claim 27, wherein the information regarding the status of the filter fleece can be retrieved and/or displayed on demand or automatically.

29. The apparatus according to claim 27 or 28, wherein the information regarding the status of the filter fleece can be measured and/or detected and/or determined and/or received and/or stored and/or transmitted by the apparatus.

30. The apparatus for filtering air flows according to claim 1, comprising a filter frame and a filter fleece detachably arranged, on the filter frame, wherein an apparatus is on the filter frame or on the filter fleece or on a retaining device for the filter fleece for determining apparatus information regarding the status of the filter fleece, wherein an inner circumferential contour of the filter frame defines a clear width of the filter fleece through which an air flow can pass, wherein the apparatus comprises a voltage source and electronic components which are outside the inner circumferential contour, and a measuring head, which projects inwards beyond the inner circumferential contour and/or is within the inner circumferential contour.

31. The apparatus according to claim 30, wherein the measuring head is on a retaining device for the filter fleece.

32. The apparatus according to claim 31, wherein the measuring head is approximately centrally within the inner circumferential contour of the filter frame.

33. The apparatus for filtering air flows according to claim 1, comprising a filter frame and a filter fleece on the filter frame, wherein an apparatus is on the filter frame or on the filter fleece or on a retaining device for the filter fleece for measuring apparatus information regarding the status of the filter fleece.
